(19) United States
(12) Patent Application Publication
(10) Pub. No.: US 2025/0282068 A1
(43) Pub. Date: Sep. 11, 2025

(54) CENTER AXIS BUTTON COMBINED LINER UNLOCKING FOLDING KNIFE DEVICE

(71) Applicant: Zexuan Guan, Yangjiang (CN)

(72) Inventor: Zexuan Guan, Yangjiang (CN)

(21) Appl. No.: 18/640,517

(22) Filed: Apr. 19, 2024

(30) Foreign Application Priority Data
Mar. 7, 2024 (CN) 2024204385765

(51) Int. Cl. B26B 1/04

(52) U.S. Cl. CPC B26B 1/044

(57) ABSTRACT

The invention provides a center axis button combined liner unlocking folding knife device, comprising a frame lock component or liner lock component, which is provided with first knife handle and second knife handle; knife hiding space is formed between first knife handle and second knife handle, first through hole is formed in front end of first knife handle, and second through hole is formed in front end of second knife handle; a folding knife; it also comprises an axis unlocking mechanism, and folding knife is rotatably arranged between first through hole and second through hole via axis unlocking mechanism; when axis unlocking mechanism is pressed, folding knife is unfolded to be in a straight state in a rotating way along circumferential direction after being separated from knife hiding space; conversely, when axis unlocking mechanism is loosened, folding knife can be rotated into knife hiding space along circumferential direction.

### 1. TECHNICAL FIELD

The invention relates to the technical field of knife products, in particular to a center axis button combined liner unlocking folding knife device.

### 2. BACKGROUND ART

In the current folding knife market, integral folding knife is more and more favored by consumers, consumers' requirement for various performances of the knife is higher, which not only need to comply with the use habit and has stable structure, and more importantly, they have high requirements in aspects of safety protection aspects.

For example, in China's authorized patent for invention disclosed a novel pin lock folding knife, with publication number CN203125536U, and specifically disclosed “a novel pin lock folding knife, which comprises a knife body and a knife scabbard. The knife body and one end of the knife scabbard are connected in a hinged mode through a rotary shaft. The novel pin lock folding knife is characterized in that a first notch is formed in a knife back side of the connection between the knife body and the knife scabbard, a second notch is formed in a knife edge side of the connection between the knife body and the knife scabbard, a first clamping groove is formed in the upper portion of the connection between the knife body and the knife scabbard, a pin is arranged in the first clamping groove, and corresponds to the first notch and the second notch, the pin is connected with a spring, one end of the spring is fixed on the knife scabbard, a second clamping groove is formed at the top end of the connection between the knife scabbard and the knife body, a reversely-triangular hand-pushing portion is arranged in the second clamping groove, and the lower portion of the hand-pushing portion is sleeved on the pin”, The knives of such structure will cut the hand during use, especially when closing the knife, resulting in low safety in use and poor safety protection for the user.

Therefore, the invention provides a center axis button combined liner unlocking folding knife device.

### 3. SUMMARY OF THE INVENTION

Given the above mentioned problems in prior art, the invention aims to provide a center axis button combined liner unlocking folding knife device, and the user will not cut hand in the using process, with higher protective performance and use safety.

The purpose of the invention can be realized through the following technical solution:
a center axis button combined liner unlocking folding knife device, comprising
a frame lock component or a liner lock component, which is provided with a first knife handle and a second knife handle; knife hiding space is formed between the first knife handle and the second knife handle, a first through hole is formed in the front end of the first knife handle, and a second through hole is formed in the front end of the second knife handle;
a folding knife;
it also comprises an axis unlocking mechanism, and the folding knife is rotatably arranged between the first through hole and the second through hole via the axis unlocking mechanism;
when the axis unlocking mechanism is pressed, the folding knife is unfolded to be in a straight state in a rotating way along the circumferential direction after being separated from the knife hiding space; conversely, when the axis unlocking mechanism is loosened, the folding knife can be rotated into the knife hiding space along the circumferential direction.

As a further preferred technical solution of the invention, said axis unlocking mechanism comprises
a button, a spring, an axis nail, a support cylinder and a lock component; said support cylinder is provided with a cylinder head and a longitudinal cylinder portion embedded in the second through hole, said button can be embedded into said first through hole along the longitudinal direction, the side wall of said longitudinal cylinder portion is provided with a gap portion, the top end of said spring is pressed against the lower surface of said button, and the bottom end of said spring is sleeved and fixed to the top side wall of said support cylinder;
one end of said axis nail is fixed to said button, the other end of said axis nail extends into said support cylinder and is in press contact and fit with the lock component disposed in said support cylinder, the end of said folding knife is sleeved and fixed to the outer side wall of said longitudinal cylinder portion, and said lock component projecting out of said gap portion is disposed on said second knife handle.

As a further preferred technical solution of the invention, said lock component comprises a linkage plate with a contact portion at the end and a lock brake plate; on the upper surface of said second knife handle is provided with a sunken groove, and the lower surface of said second knife handle is provided with an accommodation port in connection with said second through hole;

One end of said linkage plate extends into said gap portion and the contact portion thereof is pressed into contact with the bottom end of said axis nail, and the other end of said linkage plate is placed into said accommodation port and embedded in said lock brake plate; said lock brake plate is slidably embedded in said sunken groove and then is matched with the second knife handle in a locking mode.

As a further preferred technical solution of the invention, the surface of said button is provided with a curved surface which is concave downward;
a plurality of notch portions are provided on the peripheral annulus of said curved surface, and two adjacent said notch portions are provided at equal arcs along the circumferential direction.

As a further preferred technical solution of the invention, the end of said first knife handle in the direction away from said axis unlocking mechanism is screwed to the end of said second knife handle thereon by at least one screw.

As a further preferred technical solution of the invention, said screws are two.

As a further preferred technical solution of the invention, said first knife handle, second knife handle and folding knife are an integrated part made of steel.

As described above, the center axis button combined liner unlocking folding knife device provided by the invention has the following advantageous effects:
compared with the prior art, the invention utilizes a center axis button combined liner unlocking folding knife device, the axis unlocking mechanism is arranged, which means that, compared with the frame lock folding knife and liner lock folding knife in prior art, it added pressing unlocking function of the folding knife, and the user cannot cut hand in the using process, so that the folding knife has the advantages of higher protection and safety in use; only pressing is needed when operating, so the operation is convenient and quick.

### 4. BRIEF DESCRIPTION OF ACCOMPANY DRAWINGS

FIG. 1 is the space diagram of the center axis button combined liner unlocking folding knife device in unfolding state provided by the invention.

FIG. 2 is the main view of the center axis button combined liner unlocking folding knife device in unfolding state provided by the invention.

FIG. 3 is the sectional view along A-A of FIG. 2.

FIG. 4 is the enlarged view of position B in FIG. 3.

### 5. SPECIFIC EMBODIMENT OF THE INVENTION

The implementation methods of the invention are described below with reference to specific embodiments, and other advantages and effects of the invention will be readily apparent to those skilled in the art from the disclosure of the invention.

It should be understood that the structures, ratios, sizes, etc. shown in the drawings are only used for matching the content disclosed by the specification to be understood and read by those skilled in the art, and are not used to limit the conditions of the disclosure, so that the present disclosure is not limited to the essential meanings in the technology, and any modifications of the structures, changes of the ratio relationships, or adjustments of the sizes, without affecting the functions and the achievable objects of the invention, should still fall within the scope of the technical solution of the invention. In addition, the terms such as “upper”, “lower”, “left”, “right”, “middle” and “one” used in the specification are used for descriptive purposes only and are not intended to limit the scope of the invention, and the relative relationship between the terms may be changed or adjusted without substantial technical change. The specific structure can be explained with reference to the drawings of the invention.

### Embodiment 1

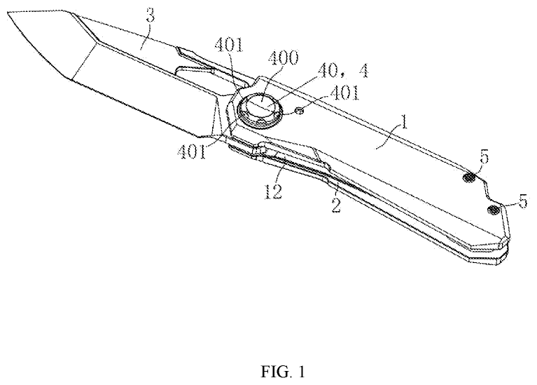

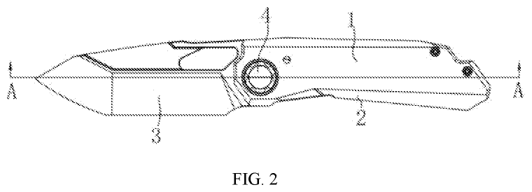

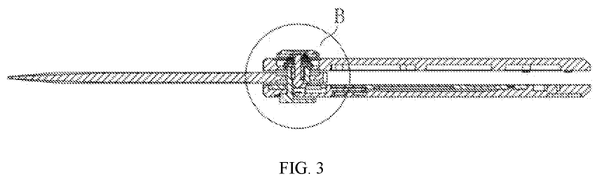

The invention provides a center axis button combined liner unlocking folding knife device, please refer to FIG. 1 to FIG. 4, comprising
a frame lock component or a liner lock component, which is provided with a first knife handle 1 and a second knife handle 2; knife hiding space 12 is formed between the first knife handle 1 and the second knife handle 2, a first through hole 10 is formed in the front end of the first knife handle 1, and a second through hole 20 is formed in the front end of the second knife handle 2;
a folding knife 3;
it also comprises an axis unlocking mechanism 4, and the folding knife 3 is rotatably arranged between the first through hole 10 and the second through hole 20 via the axis unlocking mechanism 4;
when the axis unlocking mechanism 4 is pressed, the folding knife 3 is unfolded to be in a straight state in a rotating way along the circumferential direction after being separated from the knife hiding space 12; conversely, when the axis unlocking mechanism 4 is loosened, the folding knife 3 can be rotated into the knife hiding space 12 along the circumferential direction, then the storage and unfolding of the folding knife 3 is completed, with advantages of higher protection and safety in use; only pressing is needed when operating, so the operation is convenient and quick.

It should be noted that the device of the invention can be applied in frame lock folding knife structure or liner lock folding knife structure.

With reference to FIGS. 1, 3 and 4, in the embodiment, the specific structure of said axis unlocking mechanism 4 is provided as below, said axis unlocking mechanism 4 comprises
a button 40, a spring 41, an axis nail 42, a support cylinder 43 and a lock component 44; said support cylinder 43 is provided with a cylinder head 430 and a longitudinal cylinder portion 431 embedded in the second through hole 20, said button 40 can be embedded into said first through hole 10 along the longitudinal direction, the side wall of said longitudinal cylinder portion 431 is provided with a gap portion 432, the top end of said spring 41 is pressed against the lower surface of said button 40, and the bottom end of said spring 41 is sleeved and fixed to the top side wall of said support cylinder 43;
one end of said axis nail 42 is fixed to said button 40, the other end of said axis nail 42 extends into said support cylinder 43 and is in press contact and fit with the lock component 44 disposed in said support cylinder 43, the end of said folding knife 3 is sleeved and fixed to the outer side wall of said longitudinal cylinder portion 431, and said lock component 44 projecting out of said gap portion 432 is disposed on said second knife handle 2.

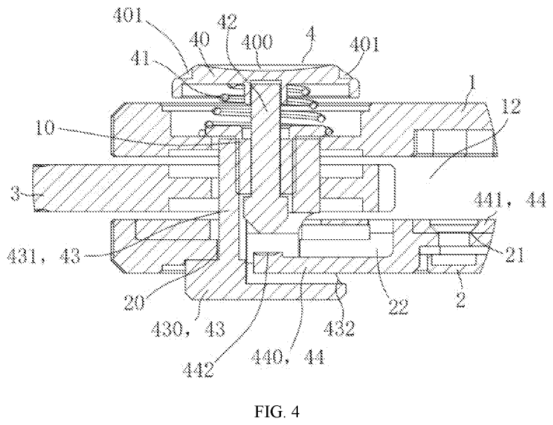

With reference to FIG. 4, in the embodiment, said lock component 44 comprises a linkage plate 440 with a contact portion 442 at the end and a lock brake plate 441; on the upper surface of said second knife handle 2 is provided with a sunken groove 21, and the lower surface of said second knife handle 2 is provided with an accommodation port 22 in connection with said second through hole 20;

One end of said linkage plate 440 extends into said gap portion 432 and the contact portion 442 thereof is pressed into contact with the bottom end of said axis nail 42, and the other end of said linkage plate 440 is placed into said accommodation port 22 and embedded in said lock brake plate 441; said lock brake plate 441 is slidably embedded in said sunken groove 21 and then is matched with the second knife handle 2 in a locking mode.

### Embodiment 2

On the basis of the embodiment 1, with reference to FIGS. 1 and 4, in the embodiment, the surface of said button 40 is provided with a curved surface 400 which is concave downward;
a plurality of notch portions 401 are provided on the peripheral annulus of said curved surface 400, and two adjacent said notch portions 401 are provided at equal arcs along the circumferential direction. By setting up said notch portions 401 as aforesaid, the user can easily trigger the whole folding knife retracting process by simply pressing his finger on said curved surface 400 during operation, which is simple and fast; and the arrangement of said notch portions 401 can make the material used for making said buttons 40 less, and the cost of making and processing is low.

With reference to FIG. 1, in the embodiment, the end of said first knife handle 1 in the direction away from said axis unlocking mechanism 4 is screwed to the end of said second knife handle 2 thereon by at least one screw 5. In the embodiment, said screws 5 are two.

In the embodiment, said first knife handle 1, second knife handle 2 and folding knife 3 are an integrated part made of steel.

As described above, the center axis button combined liner unlocking folding knife device provided by the invention has the following advantageous effects:
compared with the prior art, the invention utilizes a center axis button combined liner unlocking folding knife device, the axis unlocking mechanism is arranged, which means that, compared with the frame lock folding knife and liner lock folding knife in prior art, it added pressing unlocking function of the folding knife, and the user cannot cut hand in the using process, so that the folding knife has the advantages of higher protection and safety in use; only pressing is needed when operating, so the operation is convenient and quick.

The invention and its embodiments have been described above, but the description is not limited thereto; only one embodiment of the invention is shown in the drawings, and the actual structure is not limited thereto. In general, it is to be understood by those skilled in the art that non-creative design of structural forms and embodiments that are similar to the technical solutions without departing from the spirit of the invention shall all fall within the protective scope of the invention.

1. A center axis button combined liner unlocking folding knife device, comprising
a frame lock component or a liner lock component, which is provided with a first knife handle and a second knife handle; knife hiding space is formed between the first knife handle and the second knife handle, a first through hole is formed in the front end of the first knife handle, and a second through hole is formed in the front end of the second knife handle;
a folding knife;
it also comprises an axis unlocking mechanism, and the folding knife is rotatably arranged between the first through hole and the second through hole via the axis unlocking mechanism;
when the axis unlocking mechanism is pressed, the folding knife is unfolded to be in a straight state in a rotating way along the circumferential direction after being separated from the knife hiding space; conversely, when the axis unlocking mechanism is loosened, the folding knife can be rotated into the knife hiding space along the circumferential direction.

2. The center axis button combined liner unlocking folding knife device of claim 1 wherein said axis unlocking mechanism comprises a button, a spring, an axis nail, a support cylinder and a lock component;
said support cylinder is provided with a cylinder head and a longitudinal cylinder portion embedded in the second through hole, said button can be embedded into said first through hole along the longitudinal direction, the side wall of said longitudinal cylinder portion is provided with a gap portion, the top end of said spring is pressed against the lower surface of said button, and the bottom end of said spring is sleeved and fixed to the top side wall of said support cylinder;
one end of said axis nail is fixed to said button, the other end of said axis nail extends into said support cylinder and is in press contact and fit with the lock component disposed in said support cylinder, the end of said folding knife is sleeved and fixed to the outer side wall of said longitudinal cylinder portion, and said lock component projecting out of said gap portion is disposed on said second knife handle.

3. The center axis button combined liner unlocking folding knife device of claim 2 wherein said lock component comprises a linkage plate with a contact portion at the end and a lock brake plate; on the upper surface of said second knife handle is provided with a sunken groove, and the lower surface of said second knife handle is provided with an accommodation port in connection with said second through hole;
One end of said linkage plate extends into said gap portion and the contact portion thereof is pressed into contact with the bottom end of said axis nail, and the other end of said linkage plate is placed into said accommodation port and embedded in said lock brake plate; said lock brake plate is slidably embedded in said sunken groove and then is matched with the second knife handle in a locking mode.

4. The center axis button combined liner unlocking folding knife device of claim 2 wherein the surface of said button is provided with a curved surface which is concave downward;
a plurality of notch portions are provided on the peripheral annulus of said curved surface, and two adjacent said notch portions are provided at equal arcs along the circumferential direction.

5. The center axis button combined liner unlocking folding knife device of claim 1 wherein the end of said first knife handle in the direction away from said axis unlocking mechanism is screwed to the end of said second knife handle thereon by at least one screw.

6. The center axis button combined liner unlocking folding knife device of claim 5 wherein said screws are two.

7. The center axis button combined liner unlocking folding knife device of claim 1 wherein said first knife handle, second knife handle and folding knife are an integrated part made of steel.
